(19) United States
(12) Patent Application Publication
(10) Pub. No.: US 2020/0074004 A1
(43) Pub. Date: Mar. 5, 2020

(54) ASCERTAINING USER GROUP MEMBER TRANSITION TIMING FOR SOCIAL NETWORKING PLATFORM MANAGEMENT

(71) Applicant: International Business Machines Corporation, Armonk, NY (US)

(72) Inventors: Trudy L. Hewitt, Cary, NC (US); Jeremy R. Fox, Georgetown, TX (US); Liam S. Harpur, Skerries (IE); John Rice, Waterford (IE)

(73) Assignee: International Business Machines Corporation, Armonk, NY (US)

(21) Appl. No.: 16/115,084

(22) Filed: Aug. 28, 2018

(51) Int. Cl. G06F 17/30; H04L 29/08; G06N 7/00; G06F 17/27

(52) U.S. Cl. CPC G06F 17/30867; H04L 67/22; G06Q 50/01; G06F 17/27; H04L 67/306; G06N 7/00

(57) ABSTRACT

Social group membership management includes determining a scope of a social group of a social network. Historical activity data based upon the determined scope is received. The historical activity data is representative of user activity within the social group. A class model of the social group is created based upon the determined scope and the historical activity data. An optimal user profile for the group is created based upon the class model. A user trigger to predict a change in activity for a user of the social group is determined based upon the optimal user profile.

### TECHNICAL FIELD

The present invention relates generally to a method, system, and computer program product for social networking platform management. More particularly, the present invention relates to a method, system, and computer program product for ascertaining user group membership transition timing for social networking platform management.

### BACKGROUND

Social media platforms and other social networking platforms allow users to post content to groups associated with particular subject matter or topics and interact with other users who are members of the group. For example, a social network platform may host different groups directed to particular hobbies, activities, or skills. However, managing social media and social networking platforms across multiple teams, groups, and organizations is quickly becoming a time consuming activity for administrators of such platforms due to dynamically changing group interaction and focus. For example, as a particular user develops new skills and new focus, the user may move to a different groups that is more suitable for the user's current skill level.

### SUMMARY

The illustrative embodiments provide a method, system, and computer program product. An embodiment of a method for social group membership management includes determining a scope of a social group of a social network, and receiving historical activity data based upon the determined scope. In the embodiment, the historical activity data is representative of user activity within the social group. The embodiment further includes creating a class model of the social group based upon the determined scope and the historical activity data, and creating an optimal user profile for the group based upon the class model. The embodiment further includes determining a user trigger to predict a change in activity for a user of the social group based upon the optimal user profile.

An embodiment further includes receiving an identity of the social group, and receiving an identify of one or more users associated with the social group.

In another embodiment, the scope of the social group is determined using natural language processing. In another embodiment, the scope of the group is determined using a profile associated with the group.

In another embodiment, the class model is a latent class model. In another embodiment, the class model is created based upon the determined scope and the historical activity data using natural language processing. In another embodiment, the class model is a statistical model of the social group that models historical behaviors of users in the social group.

In another embodiment, the optimal user profile is representative of a behavior of an ideal member of the social group. In another embodiment, the change in activity for the user includes an expected time of entry of the user into a different social group. In another embodiment, the change in activity for the user includes an expected time of exit of the user from the social group.

Another embodiment further includes determining that the user trigger has reached a trigger condition, and determining, responsive to the user trigger reaching the trigger condition, a user recommendation, the user recommendation indicating a recommended action to the user. In another embodiment, the recommendation includes one or more of a recommendation to the user to leave the social group and a recommendation to the user to join a different social group.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for ascertaining user group membership transition timing for social networking platform management in accordance with an illustrative embodiment;

FIG. 4 depicts an example sequence in accordance with an illustrative embodiment; and

FIG. 5 depicts a flowchart of an example process for ascertaining user group membership transition timing for social networking platform management in accordance with an illustrative embodiment.

### DETAILED DESCRIPTION

The illustrative embodiments described herein are directed to ascertaining user group membership transition timing for social networking platform management. One or more embodiments recognize that an existing problem in social network platform management is that individuals, companies and other parties (e.g. advertisers) are consuming precious administration time and resources on users that do not warrant their attention as their trajectory suggests that they may only be “passing through” a group and not intending to remain in the group. One or more embodiments recognize that a need exists to easily identify when to stop targeting management resources and communications to certain users based on trajectory findings indicating that the users will soon exit the group. As a result, significant time and resource savings may be realized.

One or more embodiments provide for augmented intelligence for when to manage communications/interactions based on knowing that a user consumer is in transit (e.g., entering or exiting) with respect to a group of the social network platform. One or more embodiments provide for the ability to proactively identify users and expected temporal expiration period(s) of the users for studied groups of a social networking platform indicative of a time at which the users are expected to exit or enter a specific group. One or more embodiments further provide for predicting behaviors of the users based upon the expect temporal expiration periods, and the ability to identify and manage social collaboration across grouping opportunities based on exit and possible entrance of users using associated class models for a group.

In an embodiment, a system identifies a purpose and scope of a target group on a social networking platform. For example, the system may scan available data points to track 23,530 users and 592 groups. The determining of scope includes understanding the purpose and application for the studied group and the common actions of the administrator/leader of each group. For example, the system may determine that a particular administrator of a group on average sends a group communication to members of the group every five weeks. In one or more embodiments, the system analyses the description of each group to ascertain a taxonomy of the group or accesses a profile and/or preferences related to the studied group to determine the scope. In one or more embodiments, the system uses natural language processing (NLP) to determine a scope of a particular group.

In the embodiment, the system collects historical activity data that is determined to be in scope for the target group or target behaviors. In the embodiment, the system aggregates the collected data within the scope of the group and validates the collected data. In a particular embodiment, the collected data is stored in a historical database. An example of such data is “user9364 learned Python on Nov. 12, 2015”.

In the embodiment, the systems inputs the purpose and scope and collected historical data, and compares the information to determine a degree of applicability for engaging with particular users and particular groups based on known usage behaviors for members of the group. For example, the system may determine that a 79% probability exists that a user35 will join group354 within thirty weeks because two weeks of Python activity is apparent from the user's social feed as analyzed by the NLP.

In the embodiment, the system creates a categorized ideal or optimal user profile for the group that corresponds to the measured behavior and then determines longevity of the target group or membership of target users in the group with respect to an intended social collaboration footprint of the group. The optimal group user profile represents a representative behavior of an ideal member of the group. In one or more embodiments, the system determines the categorized optimal group user profile for the group using a latent class model. A latent class model is a statistical model that relates a set of observed multivariate variables to a set of latent variables. In the latent class model, a class is characterized by a pattern of conditional probabilities that indicate a chance that variables take on certain values. In one or more embodiments, the system collects patterns of activity to determine a consumption rate and a decay rate to target behaviors of the group. In one or more embodiments, the model of the ideal or optimal user profile is based on one or more of high user activity, engagement, and longevity in the target group.

In the embodiment, the system determines user behavior triggers by identifying and marking certain target behaviors/actions for instantiation or termination based on the occurrence of certain events, dates, and/or probable outcomes with respect to the group. In a particular embodiment, the system determines demographical changes based on the class model for the group including exit of and/or entrance into a member with respect to a social group.

In an event based example of exit of a user from a social group, a User A is developing Python programming skills at a velocity x, therefore the system predicts that user A will have left the “Introduction Communications circle” group in May and by October will have entered the “Python Experienced Circle” group on the social networking platform. In the example, the system can be used to alert the user and other users who receive group notifications (through feeds, etc.) of the expected movement of the group. In an event base example of entrance of user into a social group, with the exit from one demographic, there may be a direct correlation to an entrance of the user into another demographic.

In an embodiment, the system collects and stores a user profile for each individual user as the types of engagement for future learning and opportunities for temporal event termination candidates based on specific data collection and derived recommendations. In an embodiment, the system may provide recommendations to identified user candidates to implement a behavior and/or action such as recommending that a particular user join a selected new group and/or leave an existing group. In a particular embodiment, the system targets behavior based on historic/projected consumption decay of the user within a group.

One or more embodiments may improve the operation of a computer implementing a social networking platform by reducing sizes of groups by removing members from groups for which they are not longer suitable to optimize processing and other system resources.

An embodiment can be implemented as a software application. The application implementing an embodiment can be configured as a modification of an existing social networking system or platform, as a separate application that operates in conjunction with an existing social media system or platform, a standalone application, or some combination thereof.

The illustrative embodiments are described with respect to certain types of tools and platforms, procedures and algorithms, services, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

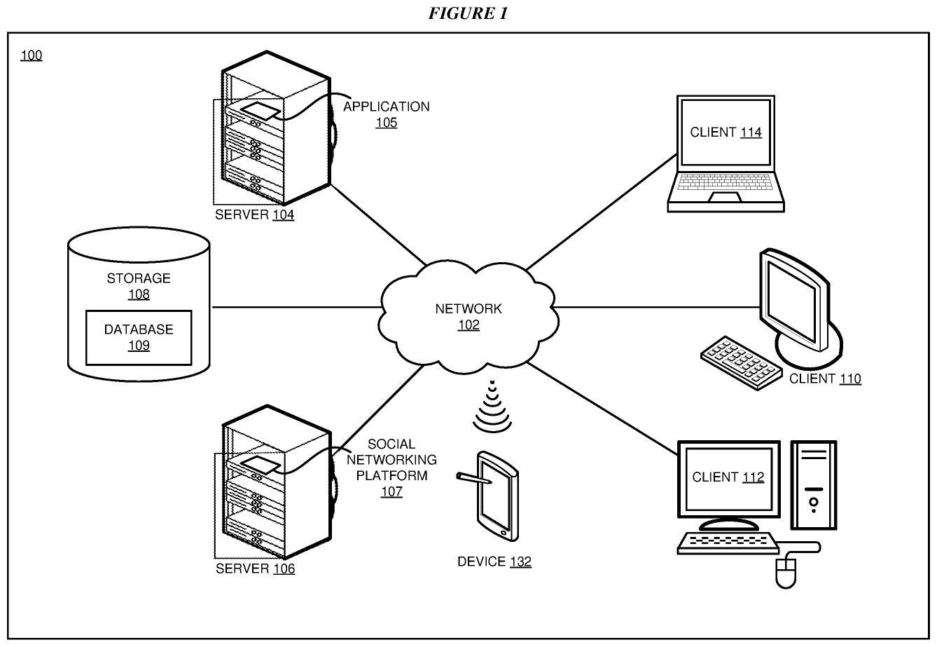

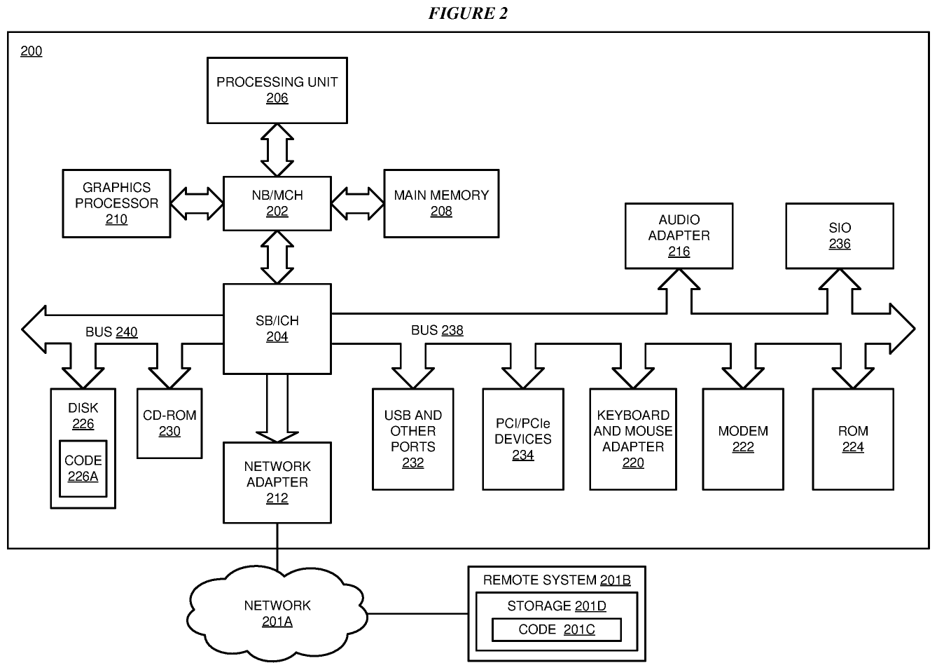

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown. Server 104 includes an application 105 that may be configured to implement one or more of the functions described herein for ascertaining user group membership transition timing for social networking platform management in accordance with one or more embodiments.

Server 106 includes a social networking platform 107 configured to allow users to post content to particular social groups and interact with other users as described herein with respect to various embodiments. Storage device 108 includes one or more databases 109 configured to store data such as historical behavior data for groups of users, group profiles or preferences, and/or user profiles.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. In another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

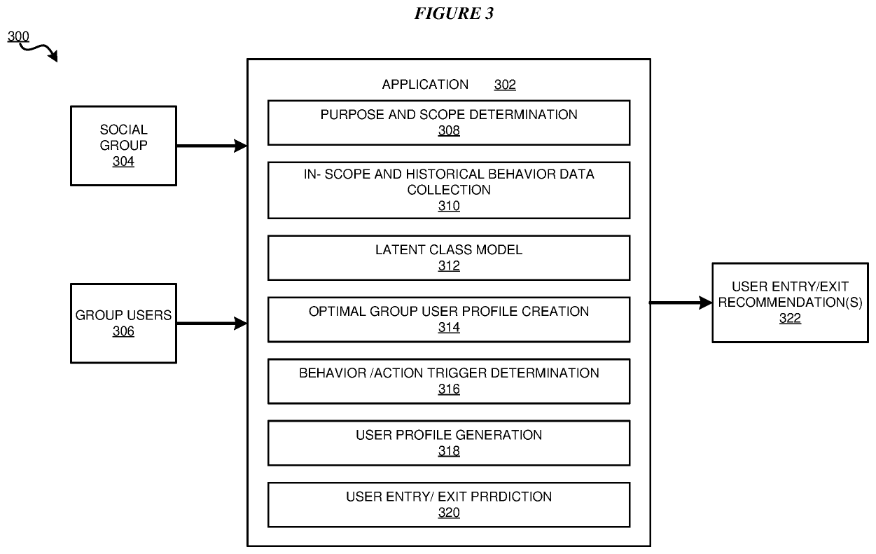

With reference to FIG. 3, this figure depicts a block diagram of an example configuration 300 for ascertaining user group membership transition timing for social networking platform management in accordance with an illustrative embodiment. The example embodiment includes an application 302. In a particular embodiment, application 302 is an example of application 105 of FIG. 1.

Application 302 receives an identification of a social group 304 of a social networking platform. Application 302 further receives an identification of group users 306 as members of the group. Application 302 includes a purpose and scope determination component 308, an in-scope and historical behavior data collection component 310, a latent class model 312, an optimal group user profile creation component 314, a behavior/action trigger determination component 316, a user profile generation component 318, and a user entry/exit prediction component 320.

In the embodiment, purpose and scope determination component 308 is configured to determine a purpose and scope of social group 304. In one or more embodiments, purpose and scope determination component 308 determines the purpose and scope of social group 304 using NLP and/or a group profile. In-scope and historical behavior data collection component 310 is configured to collect historical activity data that is determined to be in scope for social group 304. Latent class model 312 is a statistical model of social group 304 that models historical actions/behaviors of users in social group 304. optimal group user profile creation component 314 is configured to create an optimal group user profile for social group 304 using latent class model 312.

Behavior/action trigger determination component 316 is configured to determine one or more user behavior triggers based on an occurrence of certain events, dates, and/or probable outcomes of a user with respect to the group. In a particular embodiment, the system determines demographical changes based on the class model for the group including exit of and/or entrance into a member with respect to a social group. In one or more embodiments, Behavior/action trigger determination component 316 identifies users triggers that will indicate or predict a change in user activity, engagement, and longevity in the group. User profile generation component 318 is configured to generate a user profile including the triggers associated with the user. User entry/exit prediction component 320 is configured to predict entry and/or exit of a particular user of a group based upon the occurrence of one or more of the triggers and provides one or more user entry/exit recommendations to the user. For example, application 302 may provide a recommendation to a user to leave a current group of which the user is a member and join a new group that is more suitable to the user's current skill level.

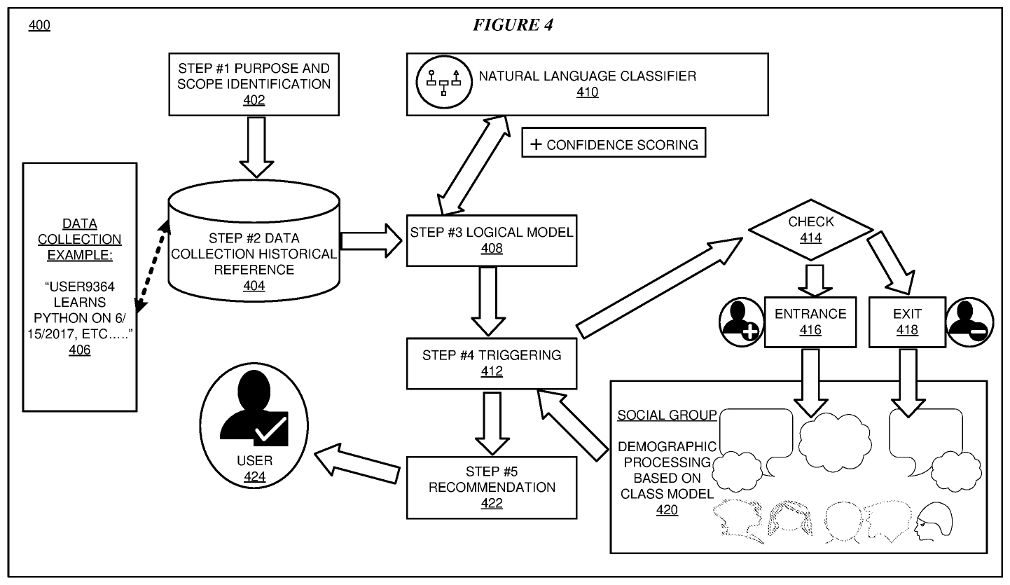

With reference to FIG. 4, this figure depicts an example sequence 400 in accordance with an illustrative embodiment. In block 402, application 105 identifies a purpose and scope of a social group on a social networking platform indicative of a purpose and application for the group as well as common actions of the administrator/leader of each group. In one or more embodiments, application 105 uses natural language processing (NLP) to determine a scope of a particular group.

In block 404, application 105 collects historical activity data based upon the scope for the group. In a particular data collection example 406 data of “user9364 learns Python on Jun. 15, 2017 . . . ” is collected. In block 408, application 105 inputs the purpose/scope and collected historical data into a logical model for the group and creates an optimal user profile for the social group. The optimal group user profile represents a representative behavior of an ideal member of the group. In one or more embodiments, the system determines the optimal group user profile for the group using the logical class model and a natural language classifier 410 based upon confidence scoring.

In block 412, application 105 determines user behavior triggers based upon the logical model by identifying and marking certain target behaviors/actions for instantiation or termination based on the occurrence of certain events, dates, and/or probable outcomes with respect to the group. In a particular embodiment, the system determines demographical changes based on the class model for the group including exit of and/or entrance into a member with respect to a social group.

In block 414, application 105 determines whether a particular user's behavior within the social group is trending away from the optimal user profile tending toward exit 418 of the group and/or trending towards entrance 416 of another social group using demographic processing 420 based upon the class model.

In block 422, upon one or more of the triggering conditions being satisfied, application 105 provides a recommendation to user 424 to implement a particular behavior and/or action such as recommending that user 424 join a selected new group and/or leave the existing group.

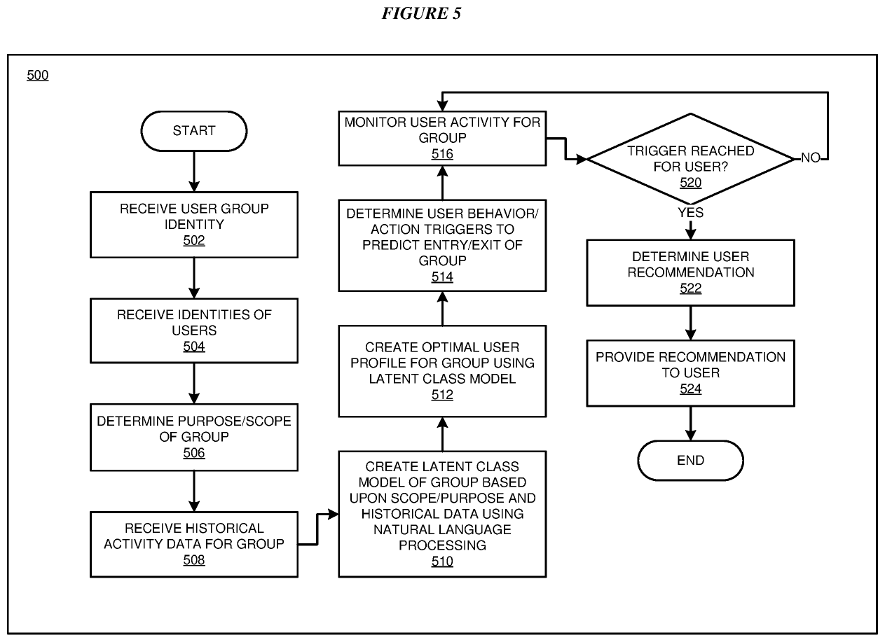

With reference to FIG. 5, this figure depicts a flowchart of an example process 500 for ascertaining user group membership transition timing for social networking platform management in accordance with an illustrative embodiment. In block 502, application 105 receives a user group identity identifying a particular social group of a social networking platform. In block 504, application 105 receives identities of users that are members of the social group. In block 506, application 105 determines a purpose/scope of the social group. In one or more embodiments, application 105 determines the purpose/scope of the social group using NLP and/or a group profile. In block 508, application 105 receives historical activity data that is determined to be in the scope for the social group.

In block 510, application 105 creates a latent class model of the social group based upon the determined purpose/scope and historical data using natural language processing. In one or more embodiments, the latent class model is a statistical model of the social group that models historical actions/behaviors of users in the social group. In block 512, application 105 creates an optimal user profile for the social group using the latent class model. In a particular embodiment, the optimal group user profile represents a representative behavior of an ideal or optimal member of the social group.

In block 514, application 105 determines one or more user behavior triggers to predict an expected time of entry of a user of the social group into another social group and/or predict and expected time of exit of a user from the social group based upon the optimal user profile. In one or more embodiments, the user behavior triggers indicate or predict a change in user activity, engagement, or longevity in the social group. In block 516, application 105 monitors the activity of one or more users for the group to determine whether a trigger condition of a user behavior trigger has been satisfied for the user. In block 520, application 105 determines if the trigger condition has been reached. If the trigger condition has not been reached, process 500 returns to block 516. If the trigger condition has been reached, process 500 continues to block 522.

In block 522, application 105 determines recommendation to the user based upon the trigger condition having been reached. In a particular embodiment, the recommendation includes a recommendation to the user to leave the social group. In another particular embodiment, the recommendation includes a recommendation to the user to join a new social group. In one or more embodiments, application 105 monitors user activity regarding the triggers and recommends a different group to the user if user activity indicates the user may be losing interest in the group. In block 524, application 105 provides the recommendation to the user. Process 500 then ends.

Thus, a computer implemented method, system or apparatus, and computer program product are provided in the illustrative embodiments for ascertaining user group membership transition timing for social networking platform management and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for social group membership management, the method comprising:
determining a scope of a social group of a social network;
receiving historical activity data based upon the determined scope, the historical activity data representative of user activity within the social group;
creating a class model of the social group based upon the determined scope and the historical activity data;
creating an optimal user profile for the social group based upon the class model;
determining a user trigger to predict a change in activity for a user of the social group based upon the optimal user profile;
determining that the user trigger has reached a trigger condition; and
reducing, responsive to the user trigger reaching the trigger condition, membership of the social group by removing the user from the social group, wherein reducing membership causes, from a memory storage, a deletion of a subset of data associated with the social group.

2. The method of claim 1, further comprising:
receiving an identity of the social group; and
receiving an identity of one or more users associated with the social group.

3. The method of claim 1, wherein the scope of the social group is determined using natural language processing.

4. The method of claim 1, wherein the scope of the group is determined using a profile associated with the group.

5. The method of claim 1, wherein the class model is a latent class model.

6. The method of claim 1, wherein the class model is created based upon the determined scope and the historical activity data using natural language processing.

7. The method of claim 1, wherein the class model is a statistical model of the social group that models historical behaviors of users in the social group.

8. The method of claim 1, wherein the optimal user profile is representative of a behavior of an ideal member of the social group.

9. The method of claim 1, wherein the change in activity for the user includes an expected time of entry of the user into a different social group.

10. The method of claim 1, wherein the change in activity for the user includes an expected time of exit of the user from the social group.

11. The method of claim 1, further comprising:
determining, responsive to the user trigger reaching the trigger condition, a user recommendation, the user recommendation indicating a recommended action to the user.

12. The method of claim 11, wherein the recommendation includes one or more of a recommendation to the user to leave the social group and a recommendation to the user to join a different social group.

13. A computer usable program product comprising one or more computer-readable storage devices, and program instructions stored on at least one of the one or more storage devices, the stored program instructions comprising:
program instructions to determine a scope of a social group of a social network;
program instructions to receive historical activity data based upon the determined scope, the historical activity data representative of user activity within the social group;
program instructions to create a class model of the social group based upon the determined scope and the historical activity data;
program instructions to create an optimal user profile for the social group based upon the class model;
program instructions to determine a user trigger to predict a change in activity for a user of the social group based upon the optimal user profile;
program instructions to determine that the user trigger has reached a trigger condition; and
program instructions to reduce, responsive to the user trigger reaching the trigger condition, membership of the social group by removing the user from the social group, wherein reducing membership causes, from a memory storage, a deletion of a subset of data associated with the social group.

14. The computer usable program product of claim 13, further comprising:
program instructions to receive an identity of the social group; and
program instructions to receive an identity of one or more users associated with the social group.

15. The computer usable program product of claim 13, wherein the scope of the social group is determined using natural language processing.

16. The computer usable program product of claim 13, wherein the scope of the group is determined using a profile associated with the group.

17. The computer usable program product of claim 13, wherein the class model is a latent class model.

18. The computer usable program product of claim 13, wherein the computer usable code is stored in a computer readable storage device in a data processing system, and wherein the computer usable code is transferred over a network from a remote data processing system.

19. The computer usable program product of claim 13, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to determine a scope of a social group of a social network;
program instructions to receive historical activity data based upon the determined scope, the historical activity data representative of user activity within the social group;
program instructions to create a class model of the social group based upon the determined scope and the historical activity data;
program instructions to create an optimal user profile for the group based upon the class model;
program instructions to determine a user trigger to predict a change in activity for a user of the social group based upon the optimal user profile;
program instructions to determine that the user trigger has reached a trigger condition; and
program instructions to reduce, responsive to the user trigger reaching the trigger condition, membership of the social group by removing the user from the social group, wherein reducing membership causes, from a memory storage, a deletion of a subset of data associated with the social group.
